(19) United States
(12) Patent Application Publication
(10) Pub. No.: US 2025/0378980 A1
(43) Pub. Date: Dec. 11, 2025

(54) FEEDBACK DEVICE AND OPERATION INPUT APPARATUS

(71) Applicant: AAC Technologies Pte. Ltd., Singapore (SG)

(72) Inventor: Takashi Iwasaki, Osaka (JP)

(21) Appl. No.: 19/000,558

(22) Filed: Dec. 23, 2024

(30) Foreign Application Priority Data
Jun. 7, 2024 (JP) 2024093319

(51) Int. Cl. H01F 7/08; A63F 13/285; H01F 7/06

(52) U.S. Cl. CPC H01F 7/081; A63F 13/285; H01F 7/064

(57) ABSTRACT

A feedback device and an operation input apparatus are provided. The feedback device includes a mounting base, an operational mechanism, a position detection mechanism, and a feedback mechanism. The operational mechanism includes an operational component and a first magnet. The feedback mechanism includes a driving assembly and a second magnet, the driving assembly is disposed on the mounting base, the second magnet is connected to the driving assembly, the second magnet is spaced apart from the first magnet, the second magnet cooperates with the first magnet to control a rotating speed of the operational component. According to the feedback device, even repeated pressing or excessive force applied to the operational mechanism does not degrade a connection between the operational mechanism and the feedback mechanism due to fatigue or wear, thereby improving operational reliability of the feedback device and enhancing immersive experience during gameplay.

### TECHNICAL FIELD

The present disclosure relates to the field of game controllers, and in particular to a feedback device and an operation input apparatus.

### BACKGROUND

In order to improve user experience, some operation input apparatus, including conventional game controllers and newer augmented reality (AR)/virtual reality (VR) handheld controllers, are provided with variable tactile feedback devices that allow users to simulate intensity of forces in game scenarios by applying pressure on handles or buttons of the operation input apparatus using hands, which enables haptic feedback functionality. When a corresponding button is pressed, a corresponding operation input apparatus responds with a counterforce, thereby simulating various tactile sensations.

In the related art of the operation input apparatus, each button is connected to a corresponding variable tactile feedback device in a physical connecting manner, such as a gear, and when each button is repeatedly used or forcibly pressed, a connection between each button and the corresponding variable tactile feedback device may be degrade due to fatigue and wear, thereby causing malfunction of the corresponding variable tactile feedback device, reducing operational reliability, and diminishing immersive experience during gameplay, moreover, mechanical noise may be generated in a process of pressing each button, which negatively impacts the user experience.

### SUMMARY

To address above problems in the related art, the present disclosure aims to provide a feedback device and an operation input apparatus for improving operational reliability and enhancing immersive experience during gameplay.

In order to achieve above aims, the present disclosure specifically adopts following technical solutions.

The present disclosure provides the feedback device, including a mounting base, an operational mechanism, a position detection mechanism, and a feedback mechanism. The operational mechanism includes an operational component and a first magnet, the operational component is rotatably connected to the mounting base, and the first magnet is connected to the operational component. The position detection mechanism is disposed on the mounting base and is configured to detect displacement information of the operational component and correspondingly output a first signal. The feedback mechanism includes a driving assembly and a second magnet, the driving assembly is disposed on the mounting base, the second magnet is connected to the driving assembly, the second magnet is spaced apart from the first magnet, the second magnet cooperates with the first magnet to control a rotating speed of the operational component.

As an improvement, the position detection mechanism includes a position detection magnet and a position detection assembly, the position detection magnet is connected to the operational component and is disposed at one side of the first magnet away from the second magnet, the position detection assembly is disposed on the mounting base and is configured to detect a magnetic flux of the position detection magnet, so as to detect the displacement information of the operational component and correspondingly output the first signal.

As an improvement, the position detection assembly includes a detection circuit board and a detection component, the detection circuit board is disposed on the mounting base, the detection component is disposed on the detection circuit board, and the detection component is disposed corresponding to the position detection magnet.

As an improvement, the position detection mechanism further includes a reset magnetic yoke, the operational component includes an accommodating groove at one side thereof facing the position detection magnet, and the reset magnetic yoke is connected to the mounting base and is disposed in the accommodating groove. The reset magnetic yoke is configured to cooperate with the position detection magnet, and the reset magnetic yoke drives the operational component to return to an initial position.

As an improvement, the position detection mechanism further includes a holder and a sensing circuit assembly, the holder is disposed on the mounting base, and the sensing circuit assembly is disposed on the holder. The sensing circuit assembly is configured to sense a pressing operation of the operational component and correspondingly output a second signal.

As an improvement, the sensing circuit assembly includes a sensing circuit board and a buffering component, the sensing circuit board is disposed on the holder, the buffering component is disposed on the sensing circuit board, and the buffering component abuts against the operational component.

As an improvement, the driving assembly includes a connecting component, a driving component, and a driving circuit board. The connecting component is rotatably connected to the mounting base, the driving component is connected to the connecting component, the driving circuit board is disposed on the mounting base and is connected to the driving component, the driving circuit board is configured to connect to a power supply device, and the second magnet is connected to the connecting component.

As an improvement, the driving component include a first driving magnet, a second driving magnet, and a driving coil. The first driving magnet and the second driving magnet are spaced apart along a width direction of the mounting base, one end of the connecting component away from the second magnet is disposed between the first driving magnet and the second driving magnet, the driving coil is connected to the one end of the connecting component away from the second magnet, and the driving coil is electrically connected to the driving circuit board.

As an improvement, the driving component includes a first driving coil, a second driving coil, and a driving magnet. The first driving coil and the second driving coil are spaced apart along the width direction of the mounting base, one end of the connecting component away from the second magnet is disposed between the first driving coil and the second driving coil, the driving magnet is connected to the one end of the connecting component away from the second magnet, and the first driving coil and the second driving coil are electrically connected to the driving circuit board.

As an improvement, the driving assembly includes an electric motor and a driving circuit board, the electric motor is disposed on the mounting base and is connected to the driving circuit board, the second magnet is connected to the electric motor.

The present disclosure further provides the operation input apparatus, including the feedback device as foregoing.

Compared with the related art, the feedback device provided by the present disclosure at least has following beneficial effects.

According to the present disclosure, the operational mechanism includes the first magnet, the feedback mechanism includes the second magnet, the second magnet is spaced apart from the first magnet, and the second magnet cooperates with the first magnet to control a rotating speed of the operational component. Since there is no direct physical connection between the operational mechanism and the feedback mechanism, when using the feedback mechanism to drive the operational mechanism at any position to generate acceleration or resistance sensations, even repeated pressing or excessive force applied to the operational mechanism does not degrade a connection between the operational mechanism and the feedback mechanism due to fatigue or wear, thereby improving the operational reliability of the feedback device and enhancing the immersive experience during gameplay. Additionally, mechanical noise generated when pressing the operational mechanism is reduced, in this way, overall quality of the feedback device is improved to ensure a superior user experience.

### BRIEF DESCRIPTION OF DRAWINGS

FIG. 1 is a structural schematic diagram of a feedback device according to one embodiment of the present disclosure.

FIG. 2 is a cross-sectional schematic diagram of the feedback device in a non-working state according to one embodiment of the present disclosure.

FIG. 3 is a cross-sectional schematic diagram of the feedback device in a working state according to one embodiment of the present disclosure.

FIG. 4 is a side structural schematic diagram of the feedback device according to one embodiment of the present disclosure.

FIG. 5 is a cross-sectional schematic diagram of the feedback device according another embodiment of the present disclosure.

FIG. 6 is a structural schematic diagram of a first magnet and a second magnet of the feedback device according to one embodiment of the present disclosure.

FIG. 7 is a structural schematic diagram of the first magnet and the second magnet of the feedback device according to another embodiment of the present disclosure.

FIG. 8 is a structural schematic diagram of a driving component of the feedback device according to another embodiment of the present disclosure.

FIG. 9 is a structural schematic diagram of an operation input apparatus according to one embodiment of the present disclosure.

FIG. 10 is a structural schematic diagram of the operation input apparatus according to another embodiment of the present disclosure.

Reference numerals in the drawings: 1. mounting base; 11. second mounting hole; 12. fourth mounting hole; 2. operational mechanism; 21. operational component; 210. pressing portion; 211; first rotating portion; 212. accommodating groove; 22. first magnet; 3. position detection mechanism; 31. position detection magnet; 32. position detection assembly; 320. detection circuit board; 321. detection component; 33. reset magnetic yoke; 34. holder; 35. sensing circuit assembly; 350. sensing circuit board; 351. buffering component; 4. feedback mechanism; 41. driving assembly; 410. connecting component; 410a. connecting portion; 410b. second rotating component; 410c. protrusion; 411. driving component; 411a. first driving magnet; 411b. driving coil; 411d. electric motor; 411e. first driving coil; 411f. driving magnet; 412. driving circuit board; 42. second magnet; 43. housing magnetic yoke; 5. first rotating shaft; 6. second rotating shaft; 100. feedback device; 200. operation input apparatus.

### DETAILED DESCRIPTION OF EMBODIMENTS

To make objectives, technical solutions, and advantages of the present disclosure clearer, the following further describes the present disclosure in detail with reference to accompanying drawings and embodiments. It should be understood that specific embodiments described herein are only used to explain the present disclosure and are not intended to limit the present disclosure.

In description of the present disclosure, unless expressly specified and limited otherwise, terms “first” and “second” are used for descriptive purposes only and are not to be construed as indicating or implying relative importance; unless otherwise specified or stated, a term “a plurality of” refers to more than two, and a term “many kinds of” refers to more than two; terms “connect”, “fix”, etc. should be understood in a broad sense, for example, the “connect” may be a fixed connection, a removable connection, an integral connection, or an electrical connection; the “connect” may also be a direct connection or an indirect connection through an intermediary medium. For those who skilled in the art, specific meanings of the above terms in the present disclosure may be understood according to specific situations.

Further, in the description of the present specification, it should be understood that terms, such as “upper” and “lower”, described in the embodiments of the present disclosure are described with an angle shown in the accompanying drawings, and should not be construed as limiting the embodiments of the present disclosure. In addition, in the context, it should be further understood that when a component is connected “on” or “below” another component, the component may not only be directly connected “on” or “below” another component, or may be indirectly connected “on” or “below” another component through an intermediate component.

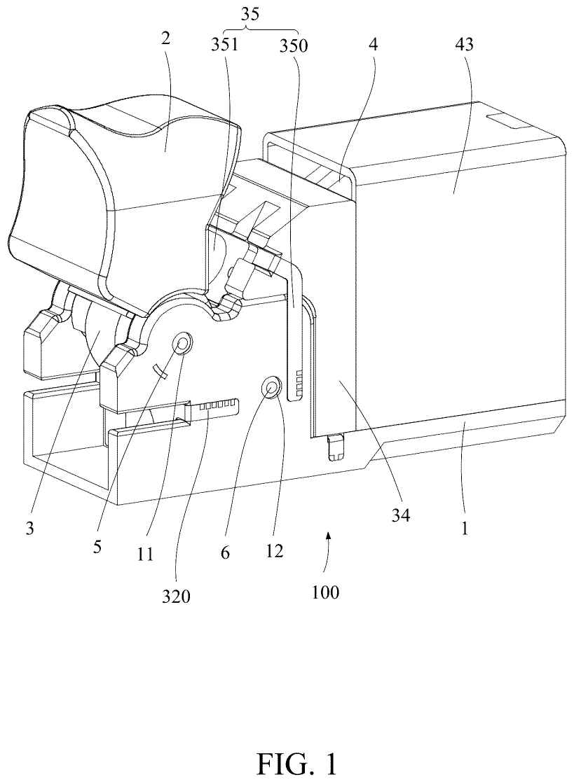

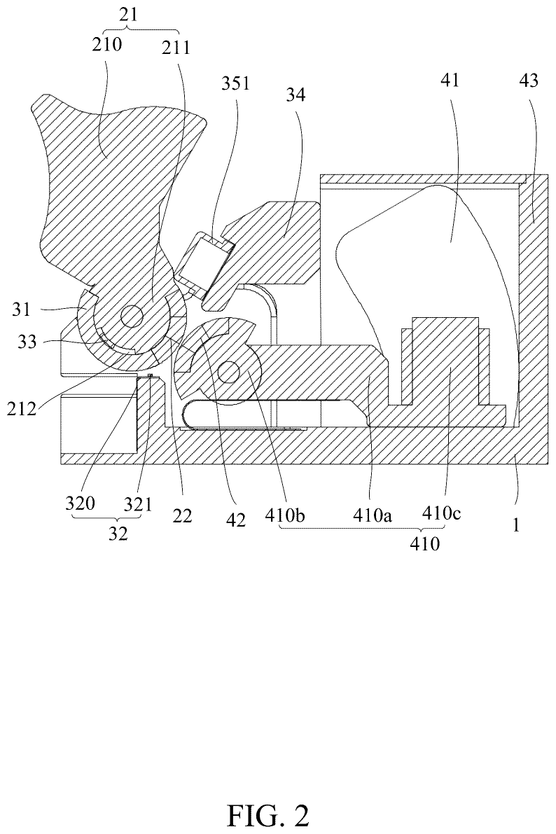

As shown in FIGS. 1-2, FIG. 1 is a structural schematic diagram of a feedback device according to one embodiment of the present disclosure, AND FIG. 2 is a cross-sectional schematic diagram of the feedback device in a non-working state according to one embodiment of the present disclosure.

The embodiments of the present disclosure provides the feedback device 100, including a mounting base 1, an operational mechanism 2, a position detection mechanism 3, and a feedback mechanism 4. The operational mechanism 2 includes an operational component and a first magnet 22, the operational component 21 is rotatably connected to the mounting base 1, and the first magnet 22 is connected to the operational component 21.

The position detection mechanism 3 is disposed on the mounting base 1 and is configured to detect displacement information of the operational component 21 and correspondingly output a first signal.

The feedback mechanism 4 includes a driving assembly 41 and a second magnet 42, the driving assembly 41 is disposed on the mounting base 1, the second magnet 42 is connected to the driving assembly 41, the second magnet 42 is spaced apart from the first magnet 22, the second magnet 42 cooperates with the first magnet 22 to control a rotating speed of the operational component 21. Specifically, a distance between the first magnet 22 and the second magnet 42 may be set according to requirements, as long as a magnetic connection is maintained between the first magnet 22 and the second magnet 42.

When feedback is required, the position detection mechanism 3 obtains information of relative position of the operational component 21 of the operational mechanism 2. Subsequently, the feedback mechanism 4 is controlled to control the rotating speed of the operational component 21 based on different gaming scenarios presented on various terminals, such as computers, tablets, and other electronic devices. In this way, the operational component generates acceleration or resistance sensations, thereby enhancing a feedback effect, achieving interaction between game contents and users, improving real experience of the users, and enhancing immersive experience during gameplay, so as to provide the users with a more authentic and engaging gaming experience.

According to the present disclosure, the operational mechanism 2 includes the first magnet 22, the feedback mechanism 4 includes the second magnet 42, the second magnet 42 is spaced apart from the first magnet 22, and the second magnet 42 cooperates with the first magnet 22 to control a rotating speed of the operational component 21. Since there is no direct physical connection between the operational mechanism 2 and the feedback mechanism 4, when using the feedback mechanism 4 to drive the operational mechanism 2 at any position to generate the acceleration or the resistance sensations, even repeated pressing or excessive force applied to the operational mechanism 2 does not degrade a connection between the operational mechanism 2 and the feedback mechanism 4 due to fatigue or wear, thereby improving operational reliability of the feedback device 100 and enhancing the immersive experience during gameplay. Additionally, mechanical noise generated when pressing the operational mechanism 2 is reduced, in this way, overall quality of the feedback device 100 is improved to ensure a superior user experience

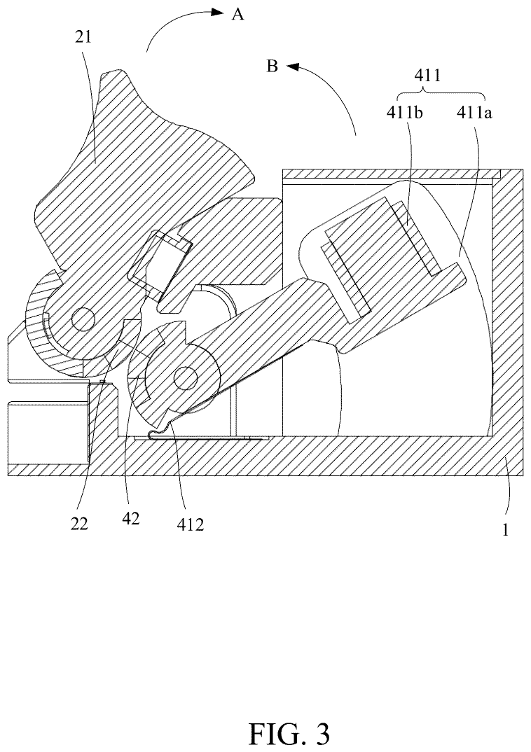

As shown in FIGS. 1-3, FIG. 3 is a cross-sectional schematic diagram of the feedback device in a working state according to one embodiment of the present disclosure. The operational component 21 includes a pressing portion 210 and a first rotating portion 211, the pressing portion 210 includes an arc-shaped surface, which is convenient for the users to press the pressing portion 210. The first rotting portion 211 is connected to the pressing portion 210, the first rotating portion 211 includes a first mounting hole, the first magnet 22 is connected to the first rotating portion 211, and the first magnet 22 extends in a first direction. The mounting base 1 includes a second mounting hole 11, the feedback device 100 further includes a first rotating shaft 5, and the first rotating shaft 5 respectively passes through the first mounting hole and the second mounting hole 11. When the pressing portion 210 is pressed, the pressing portion 210 drives the first rotating portion 211 to rotate in the first direction with the second mounting hole 11 as a center, the first rotating portion 211 rotates to drive the first magnet 22 to rotate in the first direction, the first magnet 22 rotates in the first direction to drive the second magnet 42 to rotate in a second direction, the first direction is opposite to the second direction. Specifically, the first direction is a direction A shown in FIG. 3, that is, a clockwise direction, and the second direction is a direction B shown in FIG. 3, that is, a counterclockwise direction.

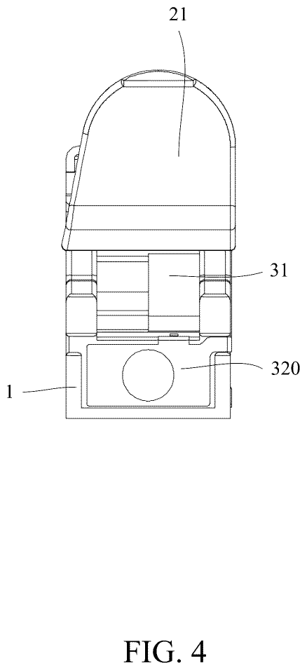

As shown in FIGS. 2-4, FIG. 4 is a side structural schematic diagram of the feedback device according to one embodiment of the present disclosure. The position detection mechanism 3 includes a position detection magnet 31 and a position detection assembly 32, the position detection magnet 31 is connected to the first rotating portion 211 and is disposed at one side of the first magnet 22 away from the second magnet 42. The position detection assembly 32 includes a detection circuit board 320 and a detection component 321, the detection circuit board 320 is disposed on the mounting base 1, the detection component 321 is disposed on the detection circuit board 320, and the detection component 321 is disposed corresponding to the position detection magnet 31, the detection component 321 is configured to detect a magnetic flux of the position detection magnet 31, and the detection circuit board 320 is configured to receive a detection result of the detection component 321 and correspondingly output the first signal, specifically, the first signal is position information of the operational component 21. In the embodiment, by observing changes of the magnetic flux of the position detection magnet 31, a position of the operational component 21 is detected, the number of components for assembling the feedback device 100 is reduced, assembly difficulty of the feedback device 100 is reduced, so as to improve portability of the feedback device 100.

In the embodiments, the position detection mechanism 3 further includes a reset magnetic yoke 33, the operational component 21 includes an accommodating groove 212 at one side thereof facing the position detection magnet 31, and the reset magnetic yoke 33 is connected to the mounting base 1 and is disposed in the accommodating groove 212. The reset magnetic yoke 33 is configured to cooperate with the position detection magnet 31, and the reset magnetic yoke 33 drives the operational component 21 to return to an initial position. When the operational component 21 is pressed, the operational component 21 rotates relative to the reset magnetic yoke 33, and when the operational component 21 is loosened, the reset magnetic yoke 33 applies a force to drive the operational component 21 to return to the initial position through a magnetic attraction force between the operational component 21 and the position detection magnet 31, specifically, the initial position refers to a position where the operational component 21 is stayed when the feedback device 100 is in the non-working state, that is, the position of the operational component 21 shown in FIG. 2. In the embodiments, the operational component 21 is returned to the initial position through the magnetic attraction force, which ensures that the connection between the operational mechanism 2 and the feedback mechanism 4 is not degraded when the operational component 21 is repeatedly used, thereby ensuring the operational reliability of the feedback device100. It may be understood that, in other embodiments, the operational component 21 may also be reset through a physical elastic component, and in a process of pressing the operational component 21 by the users, the physical elastic component is continuously compressed, and when the user releases the operational component 21, the operational component 21 is returned to the initial position by an elastic force of the physical elastic component.

In some embodiments, an actuator is provided according to required tactile feedback, for example, when the operational component 21 is pressed, the first rotating shaft 5 is provided with an electromagnetic actuator for stopping rotation of the first rotating shaft 5, etc.

As shown in FIG. 1, the position detection mechanism 3 further includes a holder 34 and a sensing circuit assembly 35, the holder 34 is disposed on the mounting base 1. The sensing circuit assembly 35 includes a sensing circuit board 350 and a buffering component 351, the sensing circuit board 350 is disposed on the holder 34, the holder 34 is configured to support and fix the sensing circuit board 350, so as to prevent the sensing circuit board 350 form loosening or falling off during a connecting process, thereby ensuring connection stability and connection reliability of the sensing circuit board 350. The buffering component 351 is disposed on the sensing circuit board 350, the operational component 21 includes an abutting portion, the buffering component 351 abuts against the abutting portion, and the buffering component 351 is configured to buffer when the pressing portion 210 is pressed to prevent the sensing circuit board 350 from being damaged due to excessive pressing force, and the buffering portion 351 further prevents external dirt and dust from entering the sensing circuit board 350 to ensure normal operation of the sensing circuit board 350. The sensing circuit board 350 is configured to sense a pressing operation of the operational component 21 and correspondingly output a second signal, specifically the second signal may, for example, serve as confirmation operation control for a terminal during the gameplay. When the users press the operational component 21, the sensing circuit board 350 correspondingly outputs the second signal, then the terminal confirms to start a game.

As shown in FIGS. 1-3, the driving assembly 41 includes a connecting component 410, a driving component 411, and a driving circuit board 412. The connecting component 410 includes a connecting portion 410a and a second rotating portion 410b, the second rotating portion 410b is connected to the connecting portion 410a, the second rotating portion 410b includes a third mounting hole, the second magnet 42 is connected to the second rotating portion 410b, and the second magnet 42 extends in the second direction. The mounting base 1 further includes a fourth mounting hole 12, the feedback device 100 further includes a second rotating shaft 6, and the second rotating shaft 6 respectively passes through the third mounting hole and the fourth mounting hole 12. The driving component 411 is connected to the connecting portion 410a, the driving circuit board 412 is disposed on the mounting base 1 and is connected to the driving component 411, the driving circuit board 412 is configured to connect to a power supply device, and the second magnet 42 is connected to the second rotating portion 410b. During feedback control of the operational component 21, the driving component 411 drives the connecting component 410 to rotate in the second direction, the connecting component 410 rotates to drive the second magnet 42 to rotate, and by applying current to the driving component 411, the connecting component 410 moves in the second direction or an opposite direction by using an electromagnetic force generated between the second magnet 42 and the first magnet 22, so as to apply acceleration or resistance to operation feeling of the operational component 21 according to an orientation of the current.

Specifically, the driving component 411 include a first driving magnet 411a, a second driving magnet (not shown in the drawings), and a driving coil 411b. The first driving magnet 411a and the second driving magnet are spaced apart along a width direction of the mounting base 1, one end of the connecting portion 410a away from the second rotating portion 410b is disposed between the first driving magnet 411a and the second driving magnet, a protrusion 410c is disposed on the one end of the connecting portion 410a away from the second rotating portion 410b, the driving coil 411b is sleeved on the protrusion 410c, and the driving coil 411b is electrically connected to the driving circuit board 412. The driving circuit board 412 is configured to connect to the power supply device, and current is applied by the power supply device, so that when the driving coil 411b is placed in a magnetic field generated by the first driving magnet 411a and the second driving magnet, a force is generated, a magnitude of the force is proportional to an amount of current applied to the driving coil 411b, so that a magnitude of a force for driving the connecting component 410 is controlled by controlling the amount of the current applied to the driving coil 411b, in this way, the operational component 21 is driven to generate acceleration and resistance, thereby enhancing the immersive experience during the gameplay. Specifically, one or more driving magnets and one or more driving coils are selected and designed according to actual requirements, which is not limited in the embodiments of the present disclosure.

In the embodiments, the mounting base 1 includes a groove, the driving circuit board 412 is bent, and the driving circuit board 412 is at least partially disposed in the groove to ensure that the connecting component 410 does not collide with the driving circuit board 412 when rotating, thereby ensuring the operational reliability of the feedback device 100.

In the embodiments, the feedback mechanism 4 further includes a housing magnetic yoke 43, the housing magnetic yoke 43 is connected to the mounting base 1 and forms an accommodating space with the mounting base 1, the driving component 411 is disposed in the accommodating space, and the housing magnetic yoke 43 is configured to guide and concentrate a magnetic field to ensure normal operation of the driving component 411.

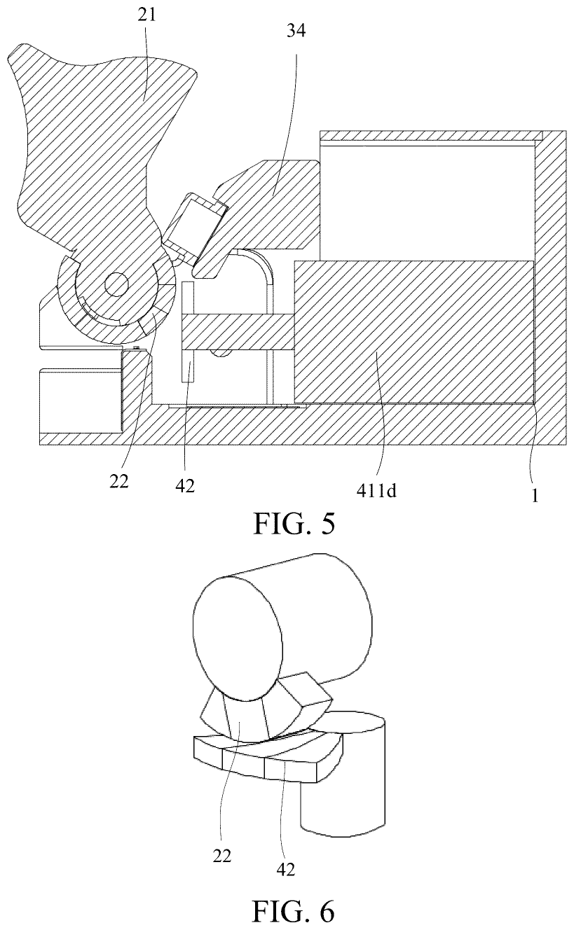

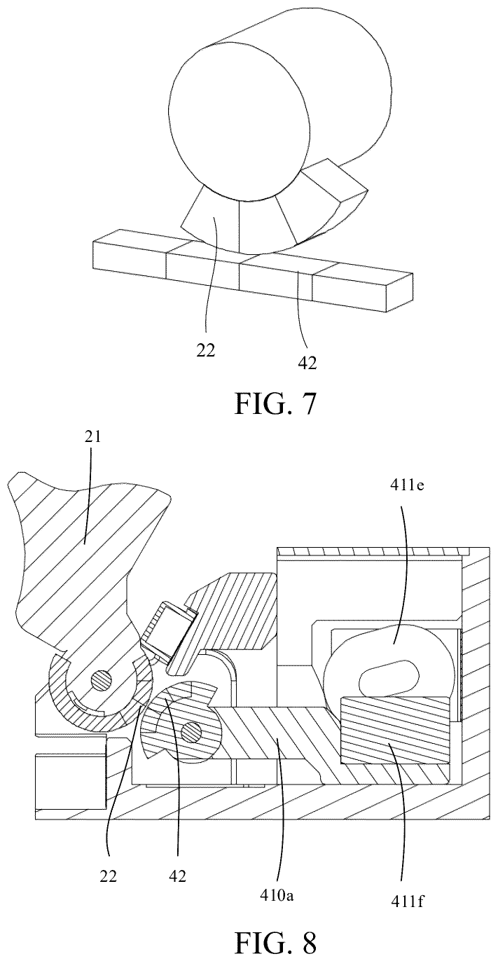

As shown in FIGS. 5-7, FIG. 5 is a cross-sectional schematic diagram of the feedback device according another embodiment of the present disclosure, FIG. 6 is a structural schematic diagram of a first magnet and a second magnet of the feedback device according to one embodiment of the present disclosure, and FIG. 7 is a structural schematic diagram of the first magnet and the second magnet of the feedback device according to another embodiment of the present disclosure. In one embodiment, the driving assembly 41 includes an electric motor 411d, a movable component, and the driving circuit board 412, the electric motor 411d and the driving circuit board 412 are respectively disposed on the mounting base 1, and the electric motor 411d is electrically connected to the driving circuit board 412. The movable component is disposed on the second rotating shaft 6 and is connected to the electric motor 411d, the second magnet 42 is connected to the movable component, and the electric motor 411d is configured to control the movable component to rotate.

In the embodiments, the first magnet 22 extends in the first direction, the second magnet 42 extends in a rotation direction of the movable component, the second magnet 42 is fan-shaped, it may be understood that, in other embodiments, a shape of the first magnet 22 and a shape of the second magnet 42 are set as required, for example, the first magnet 22 is fan-shaped, and the second magnet 42 is elongated.

As shown in FIG. 8, FIG. 8 is a structural schematic diagram of a driving component 411 of the feedback device 100 according to another embodiment of the present disclosure. In one embodiment, the driving component 411 includes a first driving coil 411e, a second driving coil, and a driving magnet 411f. The first driving coil 411e and the second driving coil are spaced apart along the width direction of the mounting base 1, one end of the connecting component 410 away from the second magnet 42 is disposed between the first driving coil 411e and the second driving coil, the driving magnet 411f is connected to the one end of the connecting component 410 away from the second magnet 42, and the first driving coil 411e and the second driving coil are electrically connected to the driving circuit board 41. Specifically, one or more driving magnets and one or more driving coils are selected and designed according to actual requirements, which is not limited in the embodiments of the present disclosure.

In a specific application scenario, using a driving game as an example, when a car in the driving game is stationary, current is not generated in the driving coil based on game information. At this time, after the users press the operational component 21, a force fed back to the users is a force driving the optional component 21 to the initial position applied by the reset magnetic yoke 33 through the magnetic attraction force between the operational component 21 and the position detection magnet 31. When the car in the driving game needs resistance, the driving component 411 provides current to the driving coil 411b to generate a force in the direction opposite to the second direction, so as to reduce a motion speed of the connecting component 410, thereby giving the users the resistance sensation when pressing the operational component 21. When the car in the driving game needs to accelerate, the driving component 411 provides current to the driving coil 411b to generate a force in the second direction, so as to increase the motion speed of the connecting component 410, thereby giving the users the acceleration sensation when pressing the operational component 21.

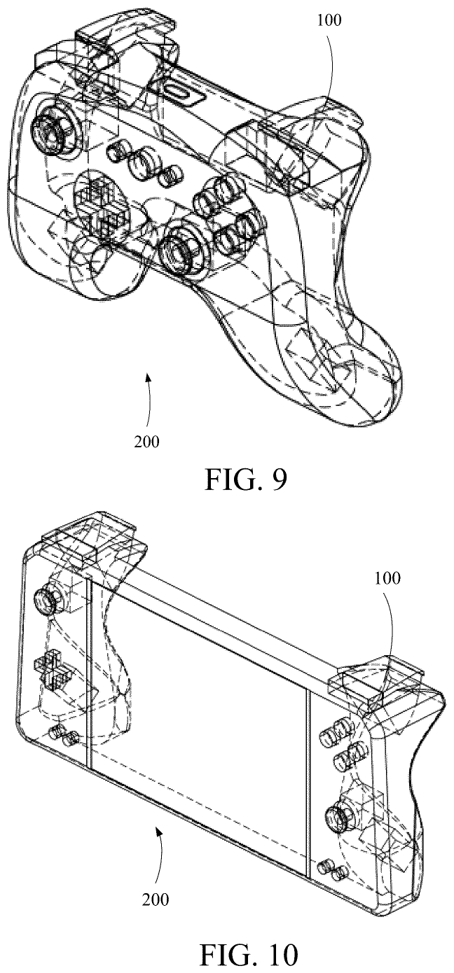

As shown in FIGS. 9 and 10, FIG. 9 is a structural schematic diagram of an operation input apparatus according to one embodiment of the present disclosure, and FIG. 10 is a structural schematic diagram of the operation input apparatus according to another embodiment of the present disclosure. Based on the embodiments, the present disclosure further provides the operation input apparatus 200, the operation input apparatus 200 includes the feedback device 100 as foregoing, the operation input apparatus may be a game controller, which is convenient for the users to operate.

The foregoing are merely preferred embodiments of the present disclosure, and a protection scope of the present disclosure is not limited thereto, any changes or substitutions that may be easily conceived of by those who skilled in the art within a technical scope disclosed in the present disclosure should be covered within the protection scope of the present disclosure. Therefore, the protection scope of the present disclosure shall be subject to a protection scope of the claims.

What is claimed is:

1. A feedback device, comprising:
a mounting base;
an operational mechanism comprising an operational component and a first magnet, wherein the operational component is rotatably connected to the mounting base, and the first magnet is connected to the operational component;
a position detection mechanism disposed on the mounting base and configured to detect displacement information of the operational component and correspondingly output a first signal; and
a feedback mechanism comprising a driving assembly and a second magnet, wherein the driving assembly is disposed on the mounting base, the second magnet is connected to the driving assembly, the second magnet is spaced apart from the first magnet, the second magnet cooperates with the first magnet to control a rotating speed of the operational component.

2. The feedback device according to claim 1, wherein the position detection mechanism comprises a position detection magnet and a position detection assembly, the position detection magnet is connected to the operational component and is disposed at one side of the first magnet away from the second magnet, the position detection assembly is disposed on the mounting base and is configured to detect a magnetic flux of the position detection magnet, so as to detect the displacement information of the operational component and correspondingly output the first signal.

3. The feedback device according to claim 2, wherein the position detection assembly comprises a detection circuit board and a detection component, the detection circuit board is disposed on the mounting base, the detection component is disposed on the detection circuit board, and the detection component is disposed corresponding to the position detection magnet.

4. The feedback device according to claim 2, wherein the position detection mechanism further comprises a reset magnetic yoke, the operational component comprises an accommodating groove at one side thereof facing the position detection magnet, and the reset magnetic yoke is connected to the mounting base and is disposed in the accommodating groove; and
the reset magnetic yoke is configured to cooperate with the position detection magnet, and the reset magnetic yoke drives the operational component to return to an initial position.

5. The feedback device according to claim 4, wherein the position detection mechanism further comprises a holder and a sensing circuit assembly, the holder is disposed on the mounting base, the sensing circuit assembly is disposed on the holder; and
the sensing circuit assembly is configured to sense a pressing operation of the operational component and correspondingly output a second signal.

6. The feedback device according to claim 5, wherein the sensing circuit assembly comprises a sensing circuit board and a buffering component, the sensing circuit board is disposed on the holder, the buffering component is disposed on the sensing circuit board, and the buffering component abuts against the operational component.

7. The feedback device according to claim 1, wherein the driving assembly comprises a connecting component, a driving component, and a driving circuit board;
the connecting component is rotatably connected to the mounting base, the driving component is connected to the connecting component, the driving circuit board is disposed on the mounting base and is connected to the driving component, the driving circuit board is configured to connect to a power supply device, and the second magnet is connected to the connecting component.

8. The feedback device according to claim 7, wherein the driving component comprises a first driving magnet, a second driving magnet, and a driving coil;
the first driving magnet and the second driving magnet are spaced apart along a width direction of the mounting base, one end of the connecting component away from the second magnet is disposed between the first driving magnet and the second driving magnet, the driving coil is connected to the one end of the connecting component away from the second magnet, and the driving coil is electrically connected to the driving circuit board.

9. The feedback device according to claim 7, wherein the driving component comprises a first driving coil, a second driving coil, and a driving magnet;
the first driving coil and the second driving coil are spaced apart along a width direction of the mounting base, one end of the connecting component away from the second magnet is disposed between the first driving coil and the second driving coil, the driving magnet is connected to the one end of the connecting component away from the second magnet, and the first driving coil and the second driving coil are electrically connected to the driving circuit board.

10. The feedback device according to claim 1, wherein the driving assembly comprises an electric motor and a driving circuit board, the electric motor is disposed on the mounting base and is connected to the driving circuit board, the second magnet is connected to the electric motor.

11. An operation input apparatus, comprising: the feedback device according to claim 1.
